(19) United States
(12) Patent Application Publication
(10) Pub. No.: US 2019/0173911 A1
(43) Pub. Date: Jun. 6, 2019

(54) Systems and Methods for Operation of a Secure Unmanned Vehicle Ecosystem

(71) Applicant: Duckyworx, Inc., Milpitas, CA (US)

(72) Inventor: Rahul Jamsandekar, Seattle, WA (US)

(21) Appl. No.: 16/194,167

(22) Filed: Nov. 16, 2018

Related U.S. Application Data
(60) Provisional application No. 62/593,798, filed on Dec. 1, 2017.

(51) Int. Cl. H04L 29/06; A63F 9/02; G05D 1/00

(52) U.S. Cl. CPC H04L 63/1466; G05D 1/0022; G05D 1/0016; A63F 9/0291

(57) ABSTRACT

Systems and methods for operation of a secure unmanned vehicle ecosystem are provided herein. An exemplary system includes an application store comprising application store servers, a user control station, a plurality of private communication towers, and a secure unmanned vehicle. In various embodiments the secure unmanned vehicle communicates with the application store servers, the user control station, and the plurality of private communication towers via a private network. In some embodiments the private network prevents malicious code from being implemented on the secure unmanned vehicle ecosystem.

### CROSS REFERENCE TO RELATED APPLICATIONS

This patent application claims the benefit of U.S. Provisional Application Ser. No. 62/593,798, filed on Dec. 1, 2017, entitled “Systems and Methods of Drone Applications,” which is hereby incorporated in its entirety including all references and appendices cited therein.

### FIELD OF THE INVENTION

The present technology of this application is directed generally to unmanned vehicle security and management, and more specifically, but not by way of limitation, to systems and methods for operation of a secure unmanned vehicle ecosystem.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

In various exemplary embodiments a system for operation of a secure unmanned vehicle ecosystem includes: (a) an application store comprising application store servers; (b) a user control station; (c) a plurality of private communication towers; and (d) a secure unmanned vehicle in communication with the application store servers, the user control station, and the plurality of private communication towers via a private network, the private network preventing malicious code from being implemented on the secure unmanned vehicle ecosystem. Other features, examples, and embodiments are described below.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding embodiments of the present disclosure so as not to obscure the disclosure with details that will be readily apparent to those of ordinary skill in the art having the benefit of the description herein.

FIG. 1 is a simplified diagram depicting components of a system for operation of a secure unmanned vehicle ecosystem according to embodiments of the present technology.

FIG. 2 is a simplified diagram showing elements of a system for operation of a secure unmanned vehicle ecosystem according to embodiments of the present technology.

FIG. 3 is another simplified diagram illustrating components of a system for operation of a secure unmanned vehicle ecosystem according to embodiments of the present technology.

FIG. 4 is a simplified diagram of a graphical user interface for operating a secure unmanned vehicle according to embodiments of the present technology.

FIG. 5 is a block diagram showing a drone module for operation of a secure unmanned vehicle ecosystem according to embodiments of the present technology.

FIG. 6 is a block diagram showing a software stack for a secure unmanned vehicle according to embodiments of the present technology.

FIG. 7 is a block diagram showing a computer system for executing embodiments of the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

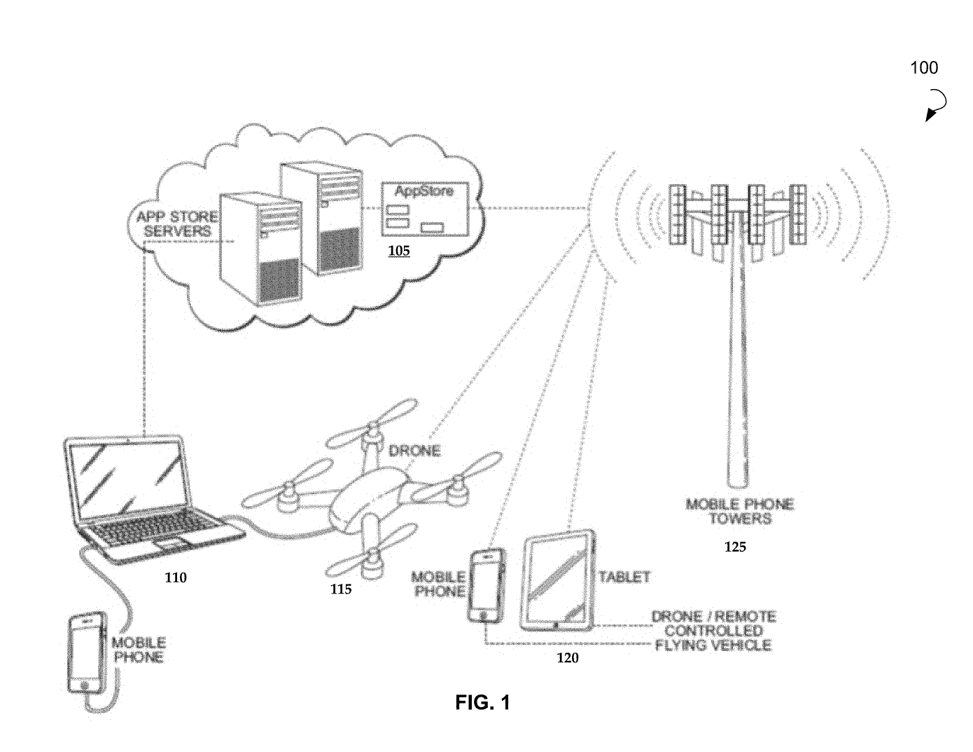

FIG. 1 is a simplified diagram depicting components of a system 100 for operation of a secure unmanned vehicle ecosystem according to embodiments of the present technology. FIG. 1 illustrates a secure unmanned vehicle ecosystem according to embodiments of the present technology. The system 100 includes an application store 105 (App Store), user computer system 110, an unmanned vehicle 115 (e.g., drone), an unmanned vehicle controller 120, and a plurality of gaming/utility towers (i.e., gaming/utility tower 125).

In some embodiments the unmanned vehicle 115 (e.g., drone) is an unmanned aerial vehicle (UAV). For example, the unmanned vehicle 115 may be a drone, an unmanned airplane, and the like. In various embodiments the unmanned vehicle 115 is an unmanned ground vehicle (UGV), an unmanned surface vehicle (USV), an unmanned underwater vehicle (UUV), and the like. In various embodiments the unmanned vehicle 115 may be any autonomous or unmanned vehicle. For example, the UAV may be a quadcopter. The unmanned vehicle 115 communicably couples to the user computer system 110, the unmanned vehicle controller 120, and the plurality of gaming/utility towers (i.e., gaming/utility tower 125) using at least one of wired and wireless communications interfaces.

In various embodiments the system 100 includes a secure unmanned vehicle ecosystem for a distributed and secure way to distribute user developed applications (APPs). The App Store 105 communicates with the user computer system 110 and the plurality of gaming/utility towers (i.e., gaming/utility tower 125). In some embodiments a user downloads APPs from the App Store 105, using App Store servers, to the user computer system 110 and the user installs the download APPs from the user computer system 110 to the unmanned vehicle 115 (e.g., drone) to create a secure unmanned vehicle ecosystem. For example, the App Store 105 distributes user developed APPs similar to the way Apple® distributes Apple® Apps using the Apple® App Store.

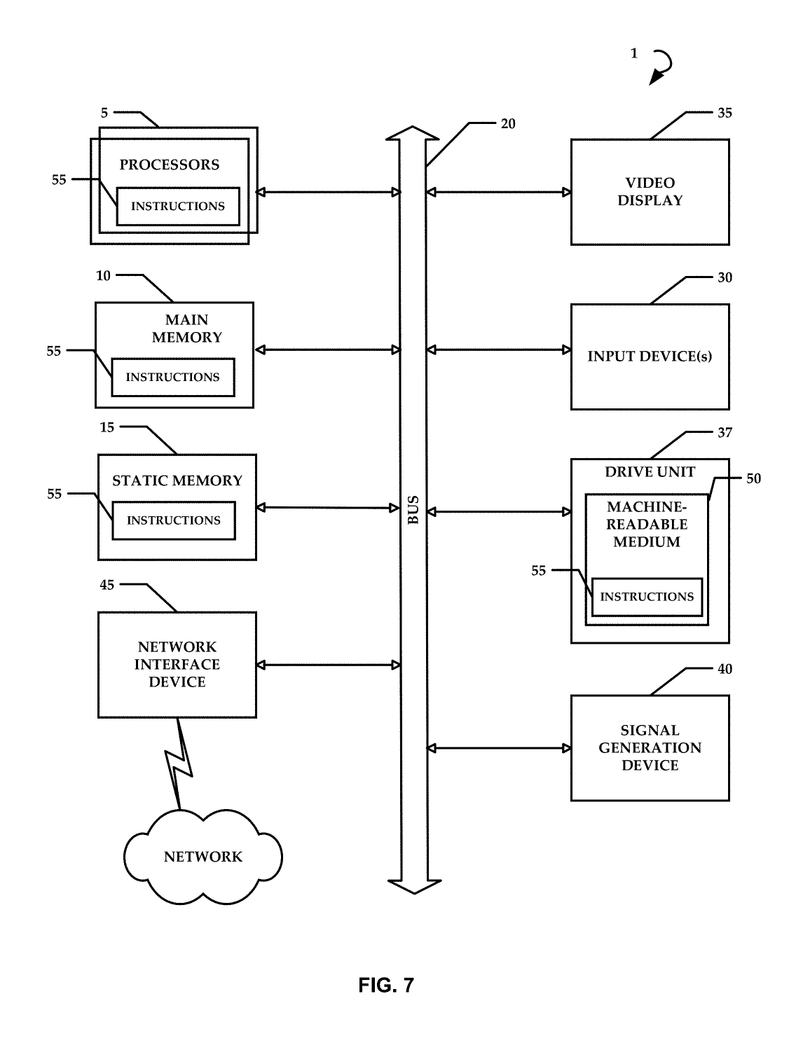

In some embodiments the application store 105 (App Store), the user computer system 110, the unmanned vehicle 115 (e.g., drone), the unmanned vehicle controller 120, and the plurality of gaming/utility towers (i.e., gaming/utility tower 125) include a computing device. A computing device is described further in relation to computing system 1 in FIG. 7.

In various embodiments the unmanned vehicle 115 (e.g., drone) communicates with the user computer system, the unmanned vehicle controller, and the plurality of gaming/utility towers (i.e., gaming/utility tower 125). The App Store 105 of the present technology and unmanned vehicle 115 (e.g., drone) both have a secure connection with a plurality of gaming/utility towers (i.e., gaming/utility tower 125). The plurality of gaming/utility towers (i.e., gaming/utility tower 125) isolate systems for a secure unmanned vehicle ecosystem from existing internet systems (e.g., existing mobile phone towers) making the plurality of gaming/utility towers (i.e., gaming/utility tower 125) secure. For example, the plurality of gaming/utility towers (i.e., gaming/utility tower 125) operate with a unique protocol and do not use Transmission Control Protocol (TCP) or Internet Protocol (IP) to transmit data to the unmanned vehicle 115 (e.g., drone). Thus, the plurality of gaming/utility towers (i.e., gaming/utility tower 125) are used for communicating secure data to the unmanned vehicle 115 (e.g., drone). Furthermore, the plurality of gaming/utility towers (i.e., gaming/utility tower 125) reduce a surface of attack for hackers that may be interested in using unmanned vehicles as carriers of malicious code or malicious hardware.

In various embodiments the plurality of gaming/utility towers (i.e., gaming/utility tower 125) are separate control towers specifically used to control the unmanned vehicle 115 (e.g., drone). Thus, the unmanned vehicle 115 (e.g., drone) uses a separate and dedicated infrastructure for security reasons. The separate and dedicated infrastructure includes the plurality of gaming/utility towers (i.e., gaming/utility tower 125) and protects the secure unmanned vehicle ecosystem from attack by malicious code because the separate and dedicated infrastructure uses a unique protocol. Furthermore, the separate and dedicated infrastructure including the plurality of gaming/utility towers (i.e., gaming/utility tower 125) reduces load of unwanted control signals on existing data networks that need network bandwidth for data intensive activities.

In various embodiments the plurality of gaming/utility towers (i.e., gaming/utility tower 125) use separate control towers specifically used to control the unmanned vehicle 115 (e.g., drone) using a private network. Suitable networks (may include or interface with any one or more of wireless networks known to those of ordinary skill in the art. Exemplary wireless networks may include communications over radio frequencies, such as for example, digital spread spectrum radio control. Other exemplary wireless networks may include, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection.

Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The private network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi° networking.

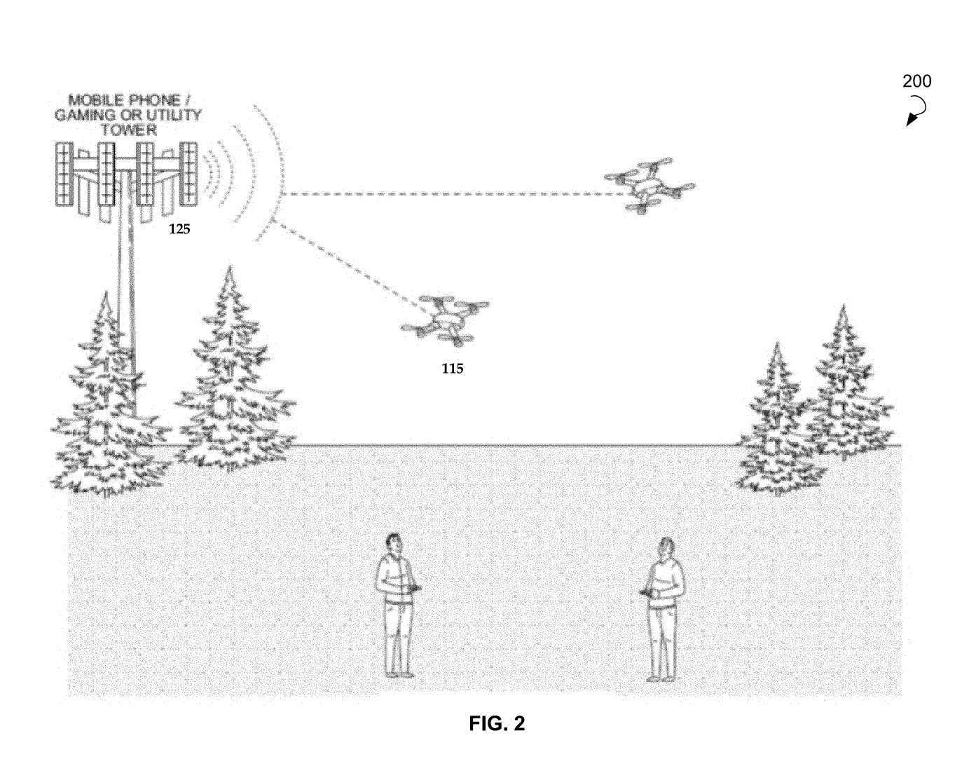

FIG. 2 is a simplified diagram showing elements of a system 200 for operation of a secure unmanned vehicle ecosystem according to embodiments of the present technology. FIG. 2 illustrates a secure unmanned vehicle ecosystem for gaming in a rural environment according to embodiments of the present technology. The system 200 includes the unmanned vehicle 115 (e.g., drone) and the plurality of gaming/utility towers (i.e., gaming/utility tower 125) in a rural environment for gaming. In various embodiments the plurality of gaming/utility towers (i.e., gaming/utility tower 125) are used to control the unmanned vehicle 115 (e.g., drone) for gamming purposes. For example, users may play a laser tagging game using the unmanned vehicle 115 (e.g., drone) and the plurality of gaming/utility towers (i.e., gaming/utility tower 125).

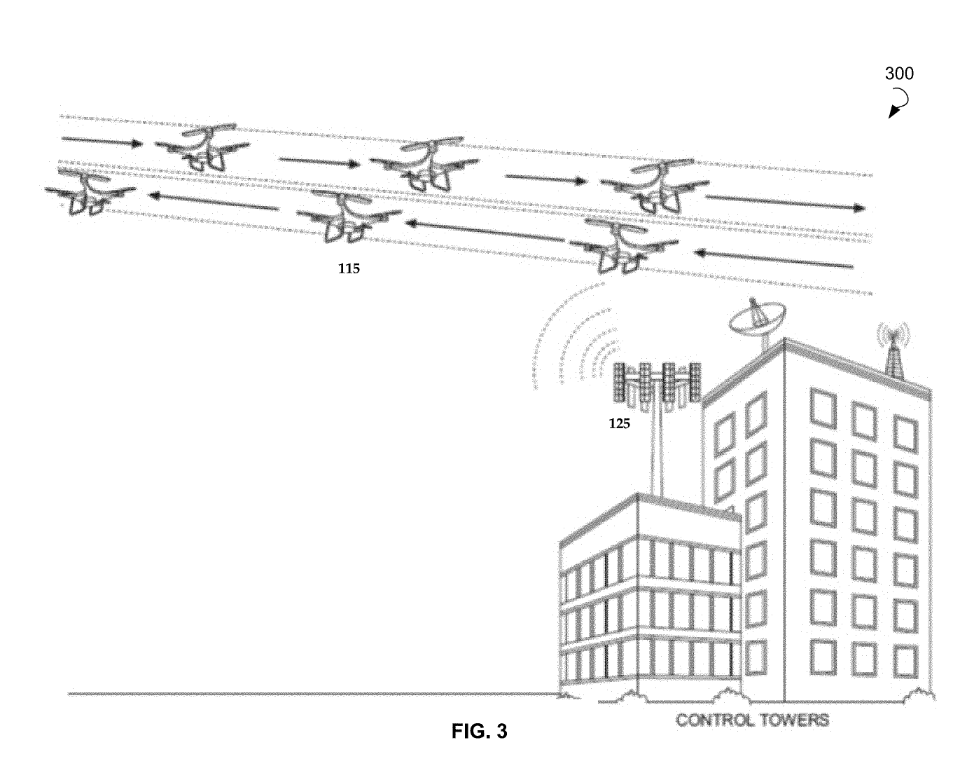

FIG. 3 is another simplified diagram illustrating components of a system 300 for operation of a secure unmanned vehicle ecosystem according to embodiments of the present technology. FIG. 3 illustrates a secure unmanned vehicle ecosystem for utility purposes in an urban environment according to embodiments of the present technology. The system 300 includes the unmanned vehicle 115 (e.g., drone) and the plurality of gaming/utility towers (i.e., gaming/utility tower 125) in an urban environment for utility purposes. In various embodiments the plurality of gaming/utility towers (i.e., gaming/utility tower 125) are used to control personal utilities including transportation. For example, the unmanned vehicle 115 (e.g., drone) and the plurality of gaming/utility towers (i.e., gaming/utility tower 125) are used for transportation of personal items of a user within the urban environment.

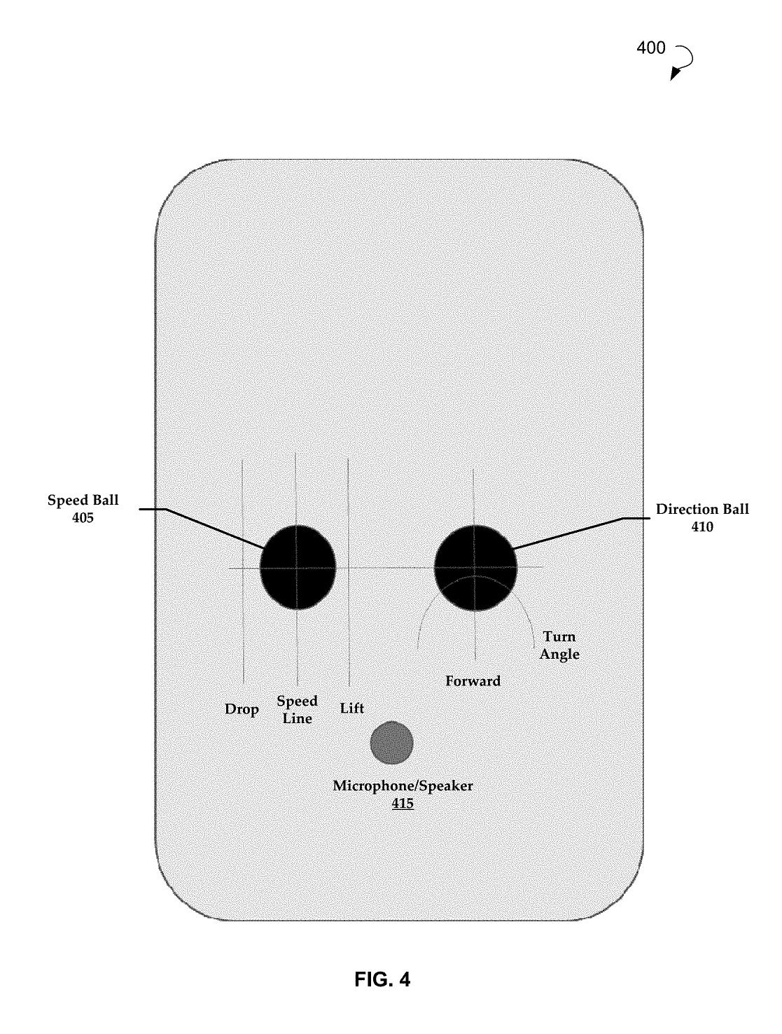

FIG. 4 is a simplified diagram of a graphical user interface 400 for operating a secure unmanned vehicle according to embodiments of the present technology. In various embodiments the graphical user interface 400 comprises tactile sensors comprising a speed ball 405 and a direction ball 410 for tactile control of the unmanned vehicle 115 (e.g., drone). In various embodiments the speed ball 405 comprises a drop sensor, a speed line sensor, and a lift sensor. In various embodiments the direction ball 410 comprises a forward sensor and a turn angle sensor. In some embodiments the graphical user interface 400 comprises a microphone/speaker 415 for voice activated control of the unmanned vehicle 115 (e.g., drone).

In various embodiments a user downloads APPs from the App Store 105, using App Store servers, to the user computer system 110 and the user installs the download APPs from the user computer system 110 to the unmanned vehicle 115 (e.g., drone) to create a secure unmanned vehicle ecosystem. The App Store 105 authenticates APPs before uploading to the App Store servers and checks the APPs for security holes including any malicious code and authenticity of software.

In various embodiments the App Store 105 authenticates APPs before downloading to the user computer system 110. For example, the user computer system 110 may be a user smart phone or another user device carrying a data connectivity chip. In some instances, the user computer system 110 uses an existing communications tower (e.g., existing mobile phone towers) or a satellite to download the APPs from the App Store servers of the App Store 105.

In some embodiments the user computer system 110 uses the plurality of gaming/utility towers (i.e., gaming/utility tower 125) to download the APPs from the App Store servers of the App Store 105. The plurality of gaming/utility towers (i.e., gaming/utility tower 125) isolate systems for a secure unmanned vehicle ecosystem from existing internet systems (e.g., existing mobile phone towers) making the plurality of gaming/utility towers (i.e., gaming/utility tower 125) secure. The plurality of gaming/utility towers (i.e., gaming/utility tower 125) are a separate network designed specifically for recreational purposes like gaming and utility applications (e.g., transportation of user goods) and for authenticity of users.

In various embodiments APPs from the App Store 105 are used to create a secure unmanned vehicle ecosystem and include various functions. In some instances functions include tactile control of the unmanned vehicle 115 (e.g., drone) using the tactile sensors of the graphical user interface 400. In some instances functions include voice activated control of the unmanned vehicle 115 (e.g., drone) using the microphone/speaker 415 of graphical user interface 400.

In some embodiments functions used to create a secure unmanned vehicle ecosystem with the graphical user interface 400 include creating a program from user inputs. For example, a user creates a personalized input by drawing using the tactile sensors comprising the speed ball 405 and the direction ball 410. In some instances a user creates a personalized input with voice commands using the microphone/speaker 415. The personalized input may be transferred to the unmanned vehicle 115 (e.g., drone) over a wired network or a separate identifier based network.

In some embodiments functions used to create a secure unmanned vehicle ecosystem with the graphical user interface 400 include verifying security of communication between the APPs and the unmanned vehicle 115 (e.g., drone).

In various embodiments functions used to create a secure unmanned vehicle ecosystem with the graphical user interface 400 include alerting a user for a malfunctioning of the unmanned vehicle 115 (e.g., drone).

In some embodiments functions used to create a secure unmanned vehicle ecosystem include controlling a hard stop of the unmanned vehicle 115 (e.g., drone) through primary test suite that is always available on object module of the unmanned vehicle 115 (e.g., drone) and can be run at any time by a user.

In various embodiments functions used to create a secure unmanned vehicle ecosystem include controlling a hard stop of the unmanned vehicle 115 (e.g., drone) explicitly by a user with an App.

In some embodiments functions used to create a secure unmanned vehicle ecosystem include informing a user in real-time a takeover status of the unmanned vehicle 115 (e.g., drone) with the takeover status including a takeover of the unmanned vehicle 115 (e.g., drone) at a code level. For example, the takeover status may be whether initial code on the unmanned vehicle 115 (e.g., drone) has been altered during flight.

In various embodiments functions used to create a secure unmanned vehicle ecosystem include informing a user in real-time a location status of the unmanned vehicle 115 (e.g., drone) using a Global Positioning System (GPS) on the unmanned vehicle 115 (e.g., drone).

In some embodiments functions used to create a secure unmanned vehicle ecosystem include altering a route of the unmanned vehicle 115 (e.g., drone) by transferring a new program to the unmanned vehicle 115 (e.g., drone) or by overriding an auto pilot mode by using tactile commands or voice commands. For example a user may override an auto pilot mode of the unmanned vehicle 115 (e.g., drone) using the graphical user interface 400 by delivering tactile input to the speed ball 405 and the direction ball 410 or verbal input the microphone/speaker 415.

In various embodiments a secure communications channel to the unmanned vehicle 115 (e.g., drone) is established for a secure unmanned vehicle ecosystem. For example when code is transferred to the unmanned vehicle 115 (e.g., drone) a library compatibility test is completed. For example, when code is transferred through a development kit or through an APP to the unmanned vehicle 115 (e.g., drone) the library compatibility test is completed that determines whether the code to be transferred is compatible with code on the unmanned vehicle 115 (e.g., drone). For example, the code to be transferred is checked against a library of codes already on the unmanned vehicle 115 (e.g., drone) for compatibility. If the code to be transferred is not compatible with the library of codes already on the unmanned vehicle, the transfer is blocked. In various embodiments a manual override by a user overcomes the block of the transfer even when the code to be transferred is not compatible with the library of codes already on the unmanned vehicle.

In various embodiments a firmware compatibility test is completed between the library of codes already on the unmanned vehicle 115 (e.g., drone) and firmware on the unmanned vehicle 115 (e.g., drone). If the firmware compatibility test determines that a code of the library of codes already on the unmanned vehicle 115 (e.g., drone) is not compatible with the firmware on the unmanned vehicle 115 (e.g., drone), a compatible framework is automatically downloaded to update the firmware.

In some embodiments the library compatibility test and the firmware compatibility test detect a malicious code on the unmanned vehicle 115 (e.g., drone). In some instances a server confirms the signature of the firmware while the unmanned vehicle 115 (e.g., drone) is in operation (e.g., in-flight).

In various embodiments programs are verified using an asymmetric key that is used to verify whenever an APP is transferred to the unmanned vehicle 115 (e.g., drone) using the using the graphical user interface 400 by receiving tactile input to the speed ball 405 and the direction ball 410 or verbal input the microphone/speaker 415.

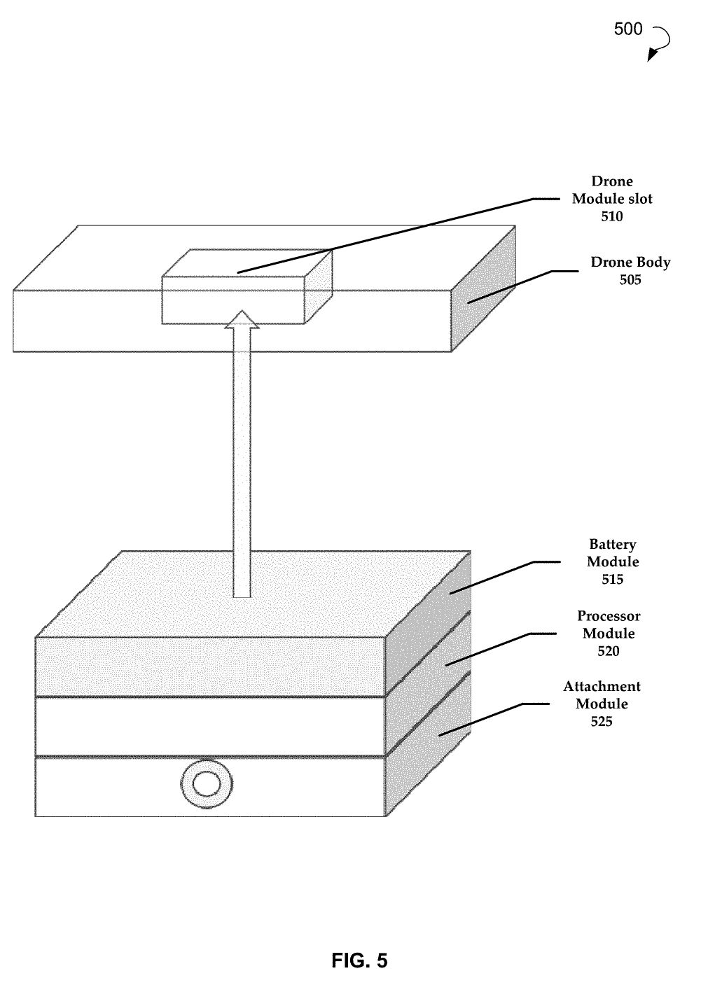

FIG. 5 is a block diagram 500 showing a drone module for operation of a secure unmanned vehicle ecosystem according to embodiments of the present technology. The drone module comprises a drone body 505 with a drone module slot 510, a battery module 515, a processor module 520, and an attachment module 525.

In various embodiments the drone module is made of a design for easy attachment of modules (e.g., the battery module 515, the processor module 520, and the attachment module 525). In various instances the drone module is weight balanced and made from material that is temperature resistant and light weight.

In some embodiments the drone body 505 uses the drone module slot 510 that is located at a position of center of gravity of the drone body 505 and a position of center of gravity of the unmanned vehicle 115 (e.g., drone). The drone module slot 510 only allows adding modules (e.g., the battery module 515, the processor module 520, and the attachment module 525) in a vertical axis.

In some embodiments the battery module 515 is attached above onto the processor module 520 and relays electrical current to the processor module 520. The battery module 515 may relay power generated by sources such as photovoltaic generated power, fuel generated power, and the like. The battery module 515 provides power to the processor module 520 and the battery module 515 may be upgraded depending on time of operation and attachments required by the unmanned vehicle 115 (e.g., drone). All attachment modules comply with the unmanned vehicle 115 (e.g., drone) object module specifications, including size, weight, and power consumption requirements.

In some embodiments the processor module 520 includes a processor with a cache storage, a dual memory store, power distribution system, input data bus, output data bus, and a separate processor to relay the commands to the hardware of the unmanned vehicle 115 (e.g., drone).

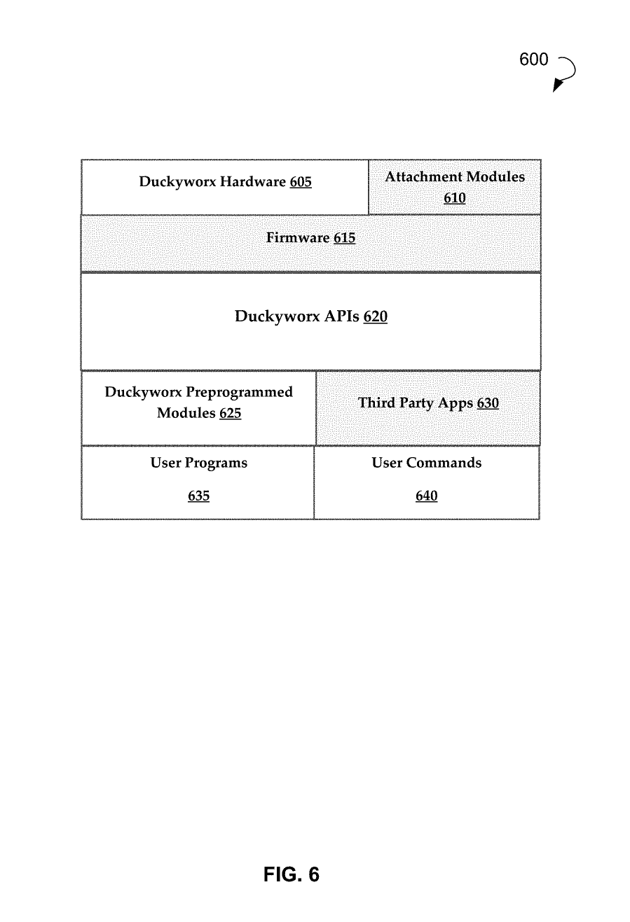

FIG. 6 is a block diagram showing a software stack 600 for a secure unmanned vehicle according to embodiments of the present technology. The software stack 600 comprises Duckyworx hardware 605, attachment modules 610, firmware 615, Duckyworx Application Program Interfaces 620 (APIs), Duckyworx preprogramed modules 625, third-party APPs 630, user programs 635, and user commands 640.

In various embodiments a version of the firmware 615 controls limitations of the Duckyworx APIs 620. The attachment modules 610 may include the battery module 515, the processor module 520, and the attachment module 525.

In some embodiments the Duckyworx APIs 620 control various activities of the unmanned vehicle 115 (e.g., drone) by control of the Duckyworx hardware 605. Functionalities of the Duckyworx APIs 620 include but are not limited to the following functionalities disclosed below.

Establishing a secure connection with the unmanned vehicle 115 (e.g., drone) by responding to calls from a smart device. For example, Input (Device ID, Connection Key, *). For example, Output (Device ID, Connection Key, Hash, *).

Run a battery test to predict the flight time available. For example, Input (Device ID, Connection Key, Hash, *, Approximate Weight of the unmanned vehicle 115 (e.g., drone) (Model ID, Attachments, Additional Payload)). For example, Output (Device ID, Connection Key, Hash, *, Time in minutes available).

Lift the unmanned vehicle 115 (e.g., drone) vertically. For example, Input (Device ID, Connection Key, Hash, *, Number of steps). For example, Output (Device ID, Connection Key, Hash, *, Ack).

Drop the unmanned vehicle 115 (e.g., drone) vertically. For example, Input (Device ID, Connection Key, Hash, *, Number of steps). For example, Output (Device ID, Connection Key, Hash, *, Ack).

Ascend the unmanned vehicle 115 (e.g., drone) vertically at an angle. For example, Input (Device ID, Connection Key, Hash, *, Number of steps, Angle). For example, Output (Device ID, Connection Key, Hash, *, Ack).

Descend the unmanned vehicle 115 (e.g., drone) vertically at an angle. For example, Input (Device ID, Connection Key, Hash, *, Number of steps, Angle). For example, Output (Device ID, Connection Key, Hash, *, Ack).

Ascend the unmanned vehicle 115 (e.g., drone) vertically over a distance at an angle. For example, Input (Device ID, Connection Key, Hash, *, Distance in Millimeters, Angle). For example, Output (Device ID, Connection Key, Hash, *, Ack).

Descend the unmanned vehicle 115 (e.g., drone) vertically over a distance at an angle. For example, Input (Device ID, Connection Key, Hash, *, Distance in Millimeters). For example, Output (Device ID, Connection Key, Hash, *, Ack).

Ascend the unmanned vehicle 115 (e.g., drone) vertically over a time at an angle. For example, Input (Device ID, Connection Key, Hash, *, Number of Milliseconds, Angle). For example, Output (Device ID, Connection Key, Hash, *, Ack).

Descend the unmanned vehicle 115 (e.g., drone) vertically over a time at an angle. For example, Input (Device ID, Connection Key, Hash, *, Number of Milliseconds, Angle). For example, Output (Device ID, Connection Key, Hash, *, Ack).

Ascend the unmanned vehicle 115 (e.g., drone) vertically to a specific height over a time. For example, Input (Device ID, Connection Key, Hash, *, Height in Millimeters, Number of Milliseconds). For example, Output (Device ID, Connection Key, Hash, *, Ack).

Descend the unmanned vehicle 115 (e.g., drone) vertically to a specific height over a time. For example, Input (Device ID, Connection Key, Hash, *, Height in Millimeters, Number of Milliseconds). For example, Output (Device ID, Connection Key, Hash, *, Ack).

Ascend the unmanned vehicle 115 (e.g., drone) vertically to a specific height at an angle. For example, Input (Device ID, Connection Key, Hash, *, Height in Millimeters, Angle). For example, Output (Device ID, Connection Key, Hash, *, Ack).

Descend the unmanned vehicle 115 (e.g., drone) vertically to a specific height at an angle. For example, Input (Device ID, Connection Key, Hash, *, Height in Millimeters, Angle). For example, Output (Device ID, Connection Key, Hash, *, Ack).

Ascend the unmanned vehicle 115 (e.g., drone) vertically to a specific height over a distance. For example, Input (Device ID, Connection Key, Hash, *, Height in Millimeters, Horizontal Distance in Millimeters). For example, Output (Device ID, Connection Key, Hash, *, Ack).

Descend the unmanned vehicle 115 (e.g., drone) vertically to a specific height over a distance. For example, Input (Device ID, Connection Key, Hash, *, Height in Millimeters, Horizontal Distance in Millimeters). For example, Output (Device ID, Connection Key, Hash, *, Ack).

Slide the unmanned vehicle 115 (e.g., drone) left number of steps. For example, Input (Device ID, Connection Key, Hash, *, Number of steps). For example, Output (Device ID, Connection Key, Hash, *, Ack).

Slide the unmanned vehicle 115 (e.g., drone) right number of steps. For example, Input (Device ID, Connection Key, Hash, *, Number of steps). For example, Output (Device ID, Connection Key, Hash, *, Ack).

Slide the unmanned vehicle 115 (e.g., drone) back number of steps. For example, Input (Device ID, Connection Key, Hash, *, Number of steps). For example, Output (Device ID, Connection Key, Hash, *, Ack).

Slide the unmanned vehicle 115 (e.g., drone) straight number of steps. For example, Input (Device ID, Connection Key, Hash, *, Number of steps). For example, Output (Device ID, Connection Key, Hash, *, Ack).

Accelerate the unmanned vehicle 115 (e.g., drone) up for milliseconds. For example, Input (Device ID, Connection Key, Hash, *, Number of Milliseconds). For example, Output (Device ID, Connection Key, Hash, *, Ack).

Accelerate the unmanned vehicle 115 (e.g., drone) down for milliseconds. For example, Input (Device ID, Connection Key, Hash, *, Number of Milliseconds). For example, Output (Device ID, Connection Key, Hash, *, Ack).

Turn the unmanned vehicle 115 (e.g., drone) Left at an angle. For example, Input (Device ID, Connection Key, Hash, *, Angle). For example, Output (Device ID, Connection Key, Hash, *, Ack)

Turn right at an angle. For example, Input (Device ID, Connection Key, Hash, *, Angle). For example, Output (Device ID, Connection Key, Hash, *, Ack).

Calculate an angle with a distance, direction, and an angle to Y-Z plane as an input.

Calculate an angle with a distance, direction and an angle to Y-Z plane as an input but with a steer back parameter and with a percentage of remaining distance, this function calls a steer back function to bring the unmanned vehicle 115 (e.g., drone) in exactly same direction as before the start of the turn.

Calculate an angle with a distance, direction, and an angle to Y-Z plane as an input but with an angle back parameter which will bring the unmanned vehicle 115 (e.g., drone) in exact same angle before the start of the turn.

Drive the unmanned vehicle 115 (e.g., drone) in a circle of a given radius and an angle to Y-Z plane.

Let the unmanned vehicle 115 (e.g., drone) throw itself for number of milliseconds with rotors off and start the rotors at the end of the interval in exact same position.

Land the unmanned vehicle 115 (e.g., drone) in an upright position in Y direction.

In various embodiments the Duckyworx preprogramed modules 625 include a basic APP for smart devices to control the unmanned vehicle 115 (e.g., drone) with tactile and voice commands. For example, a basic APP includes the graphical user interface 400 with the speed ball 405 and the direction ball 410 for tactile input. Furthermore, a basic APP includes the graphical user interface 400 with the microphone/speaker 415 for verbal input.

In various embodiments user programs 635 include a program to check locations in and around a house that can be controlled by using an App on a smart device.

In some embodiments the software stack 600 is used to control the unmanned vehicle 115 (e.g., drone) to accomplish the various functionalities using a computing system. A computing device is described further in relation to computing system 1 in FIG. 7. For example, functionalities implemented using the software stack 600 include voice commands to operate a camera of the unmanned vehicle 115 (e.g., drone) to capture video or images. Functionalities also include a laser tagging game using the unmanned vehicle 115 (e.g., drone) as shown in FIG. 2. In some instances a personalized video messaging system sends personalized video messages between players of the laser tagging game.

In some embodiments the software stack 600 is used to control the unmanned vehicle 115 (e.g., drone) to accomplish transportation purposes. For example, sending personal items of a user in an urban environment is shown in FIG. 3.

Various embodiments of the present technology can be practiced with a local computer system, and/or a cloud-based system. FIG. 7 is a diagrammatic representation of an example machine in the form of a computer system 1, within which a set of instructions for causing the machine to perform any one or more of the methodologies discussed herein may be executed. In various example embodiments the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system for operation of a secure unmanned vehicle ecosystem, the system comprising:
an application store comprising application store servers;
a user control station, the user control station comprising a graphical user interface for operating a first secure unmanned vehicle, the graphical user interface comprising:
tactile sensors comprising a speed ball and a direction ball for tactile control of the first secure unmanned vehicle;
the speed ball of the tactile sensors comprising a drop sensor, a speed line sensor, and a lift sensor;
the direction ball of the tactile sensors comprising a forward sensor and a turn angle sensor; and
a microphone for voice activated control of the first secure unmanned vehicle;
a plurality of private communication towers; and
the first secure unmanned vehicle being in communication with the application store servers, the user control station, and the plurality of private communication towers via a private network, the private network reducing a surface of attack for a hacker and preventing malicious code from being implemented on the secure unmanned vehicle ecosystem.

2. The system of claim 1, wherein the first secure unmanned vehicle further comprises a first laser transmitting device and a first laser receiving device for use in a laser tagging game.

3. The system of claim 2, further comprising a second secure unmanned vehicle in communication with the application store servers, the user control station, and the plurality of private communication towers via the private network, the second secure unmanned vehicle comprising a second laser transmitting device and a second laser receiving device for use in the laser tagging game.

4. The system of claim 3, wherein the laser tagging game is between the first secure unmanned vehicle and the second secure unmanned vehicle, the laser tagging game including personalized video messages sent between the first secure unmanned vehicle and the second secure unmanned vehicle.

5. The system of claim 4, wherein the laser tagging game comprises the first laser receiving device receiving laser input from the second laser transmitting device or the second laser receiving device receiving laser input from the first laser transmitting device.

6. The system of claim 4, wherein the first secure unmanned further comprises a first plurality of high definition cameras used for recording videos.

7. The system of claim 6, wherein the second secure unmanned further comprises a second plurality high definition cameras used for recording videos.

8. The system of claim 7, wherein the first plurality of high definition cameras and the second plurality of high definition cameras are used to record a movie.

9. The system of claim 7, wherein the first plurality of high definition cameras and the second plurality of high definition cameras are used for the laser tagging game.

10. The system of claim 1, wherein the first secure unmanned vehicle and the second secure unmanned vehicle are at least one of an unmanned aerial vehicle (UAV), an unmanned ground vehicle (UGV), an unmanned surface vehicle (USV), and an unmanned underwater vehicle (UUV).

11. The system of claim 1, wherein the first secure unmanned vehicle comprises:
a drone body; and
and a drone module slot, the drone module slot comprising a battery module, a processor module, and an attachment module.

12. The system of claim 1, wherein the first secure unmanned vehicle comprises a software stack, the software stack comprises: hardware, an attachment module, firmware, an Application Program Interface, preprogramed modules, third-party applications, user programs, and user commands.

13. A system for operation of a secure unmanned vehicle ecosystem, the system comprising:
an application store comprising application store servers;
a user control station, the user control station comprising:
a graphical user interface for operating a first secure unmanned vehicle, the graphical user interface comprising:
tactile sensors comprising a speed ball and a direction ball for tactile control of the first secure unmanned vehicle; and
a microphone for voice activated control of the first secure unmanned vehicle;
a plurality of private communication towers; and
the first secure unmanned vehicle in communication with the application store servers, the user control station, and the plurality of private communication towers via a private network, the private network reducing a surface of attack for a hacker and preventing malicious code from being implemented on the secure unmanned vehicle ecosystem; wherein the first secure unmanned vehicle comprises a first laser transmitting device and a first laser receiving device for use in a laser tagging game.

14. The system of claim 13, wherein the speed ball of the tactile sensors comprises a drop sensor, a speed line sensor, and a lift sensor; and wherein the direction ball of the tactile sensors comprises a forward sensor and a turn angle sensor.

15. The system of claim 13, further comprising a second secure unmanned vehicle in communication with the application store servers, the user control station, and the plurality of private communication towers via the private network, the second secure unmanned vehicle comprising a second laser transmitting device and a second laser receiving device for use in the laser tagging game.

16. The system of claim 15, wherein the laser tagging game comprises the first laser receiving device receiving laser input from the second laser transmitting device or the second laser receiving device receiving laser input from the first laser transmitting device.

17. A system for operation of a secure unmanned aerial vehicle (UAV) ecosystem, the system comprising:
an application store comprising application store servers;
a user control station, the user control station comprising:
a graphical user interface for operating a secure UAV, the graphical user interface comprising:
tactile sensors comprising a speed ball and a direction ball for tactile control of the secure UAV; and
a microphone for voice activated control of the secure UAV;
a plurality of private communication towers; and
the secure UAV being in communication with the application store servers, the user control station, and the plurality of private communication towers via a private network, the private network reducing a surface of attack for a hacker and preventing malicious code from being implemented on the secure UAV ecosystem; wherein the secure UAV comprises a first laser transmitting device and a first laser receiving device for use in a laser tagging game and a first plurality of high definition cameras.

18. The system of claim 17, wherein the secure UAV comprises:
a drone body; and
and a drone module slot, the drone module slot comprising a battery module, a processor module, and an attachment module.

19. The system of claim 17, wherein the secure UAV comprises a software stack, the software stack comprises: hardware, an attachment module, firmware, an Application Program Interface, preprogramed modules, third-party applications, user programs, and user commands.

20. The system of claim 17, wherein the speed ball of the tactile sensors comprises a drop sensor, a speed line sensor, and a lift sensor.
